(19) United States
(12) Patent Application Publication
(10) Pub. No.: US 2004/0024948 A1
(43) Pub. Date: Feb. 5, 2004

(54) Response reordering mechanism

(76) Inventors: Joerg Winkler, Ullersdorf (DE); Frank Barth, Radebeul (DE); Larry Hewitt, Austin, TX (US)

Correspondence Address: B. Noel Kivlin, Conley, Rose, & Tayon, P.C., P.O. Box 398, Austin, TX, 78767, US

(21) Appl. No.: 10/285,939

(22) Filed: Nov. 1, 2002

(30) Foreign Application Priority Data
Jul. 31, 2002 (DE) 102 34 934.7

(51) Int. Cl. G06F 13/36

(52) U.S. Cl. 710/311

(57) ABSTRACT

An improved response reordering technique for use in a southbridge device or I/O hub or similar devices are provided. Non-posted read requests are received from at least one requestor, and upstream commands are transmitted based on the non-posted read requests. Each of the upstream commands is uniquely identified by a command tag. When response data is received in reply to previously transmitted commands, responses are transmitted to the at least one requestor based on the response data. Transmitting the responses comprises reordering the received response data by accessing a buffer of the southbridge device. The buffer stores the received response data and has a plurality of buffer elements that are each uniquely assigned to one of the command tags.

### BACKGROUND OF THE INVENTION

1. Field of the Invention

The invention generally relates to integrated circuit chips such as southbridges or I/O hubs in computer systems, and in particular to the reordering of responses that were received out of order in reply to previous read requests.

2. Description of the Related Art

Integrated circuit chips are often used for data processing and are known to comprise a number of different circuit units. Generally, each circuit unit is for performing a specific function and of course, there may be different circuit units provided on one chip for performing the same function, or performing different functions. The circuit units may operate sequentially in time or simultaneously, and they may function independently from each other, or dependent on the operation of other circuit units.

In the latter case, the circuit units are usually interconnected via an interface to allow the circuit units to interchange data needed for making the operation of one circuit unit dependent on the operation of the other circuit unit. The data exchange is often done by sending transactions from one circuit unit to the other circuit unit. A transaction is a sequence of packets that are exchanged between the circuit units and that result in a transfer of information. The circuit unit initiating a transaction is called the source (or master), and the circuit unit that ultimately services the transaction on behalf of the source is called target. It is to be noted that there may also be intermediary units between the source and the target.

Transactions may be used to place a request, or to respond to a received request. Taking the requests, there may be distinguished posted request from non-posted requests, dependent on whether the request requires a response. Specifically, a non-posted request is a request that requires a response while a posted request does not require a response.

When focusing on the functions which are performed by the interconnected circuit units, the circuit units can often be divided into hosts and devices. The term host then means a circuit unit that provides services to the dependent device. A transaction from the host to the device is said to be downstream while a transaction in the other direction is said to be upstream. In bi-directional configurations, both the host and the device may send and receive requests and responses so that a device may be source as well as target, and also the host may function as source as well as device.

A field where such integrated circuit chips are widely used are personal computers. Referring to FIG. 1, the hardware components of a common motherboard layout are depicted. It is to be noted that this figures shows only one example of a motherboard layout, and other configurations exist as well. The basic elements found on the motherboard of FIG. 1 may include the CPU (Central Processing Unit) 100, a northbridge 105, a southbridge 110, and system memory 115.

The northbridge 105 is usually a single chip in a core-logic chipset that connects the processor 100 to the system memory 115 and, e.g., to the AGP (Accelerated Graphic Port) and PCI (Peripheral Component Interface) buses. The PCI bus is commonly used in personal computers for providing a data path between the processor 100 and peripheral devices like video cards, sound cards, network interface cards and modems. The AGP bus is a high-speed graphic expansion bus that directly connects the display adapter and system memory 115. AGP operates independently of the PCI bus. It is to be noted that other motherboard layouts exist that have no northbridge in it, or that have a northbridge without AGP or PCI options.

The southbridge 110 is usually the chip in a system core-logic chipset that controls the IDE (Integrated Drive Electronics) or EIDE (Enhanced IDE) bus, controls a USB (Universal Serial Bus) bus that provides plug-and-play support, controls a PCI-ISA (Industry Standard Architecture) bridge, manages the keyboard/mouse controller, provides power management features, and controls other peripherals.

Thus, common personal computers include southbridges 110 which are integrated circuit chips substantially as described above. Conventionally, the southbridge 110 and the northbridge 105 are interconnected by the PCI bus acting as system bus so that the northbridge 105 works as host-to-PCI bridge forming a link between the host bus that connects to the processor 100, and the PCI bus whereas the southbridge 110 works as, e.g., PCI-to-ISA bus where the ISA (Industry Standard Architecture) bus is the I/O bus. However, other chipset arrangements exist in which the northbridge 105 operates as memory controller hub and the southbridge 110 as I/O controller hub. In such structures, the northbridge 105 and the southbridge 110 are no longer interconnected by a system bus but by a specific hub interface.

To satisfy the demands for high-speed chip-to-chip communication in such hub interfaces, the HyperTransport™ technology was developed which provides a high-speed, high-performance point-to-point on-board link for interconnecting integrated circuits on a motherboard. It can be significantly faster than a PCI bus for an equivalent number of pins. The HyperTransport technology is designed to provide significantly more bandwidth than current technologies, to use low-latency responses, to provide low pin count, to be compatible with legacy computer buses, to be extensible to new system network architecture buses, to be transparent to operating systems, and to offer little impact on peripheral drivers.

The hardware components of a HyperTransport compliant southbridge device (or I/O hub) is depicted in FIG. 2. A number of bus masters 230-260 are provided for controlling peripheral system components. The controllers include a hard disk controller 230, an ethernet controller 240, a USB (Universal Serial Bus) controller 250, and an AC (Audio Codec) '97 controller 260. These controllers act as bus masters to interact with a transmit engine 220 and a receive engine 210 of the device. The transmit engine 220 receives requests from the controllers 230-260 and performs an arbitration to select at any one time one of the requestors 230-260. Based on the received requests, the transmit engine 220 sends commands to the HyperTransport interface unit 200 that interfaces to a HyperTransport compliant link. Received responses are supplied from the HyperTransport interface unit 200 to the receive engine 210 where the responses are forwarded to the respective controllers 230-260 that were the originators of the requests.

Thus, the HyperTransport interface is a split transaction interface, i.e., requests and responses are transferred on the bus as completely decoupled and independent transactions. All HyperTransport I/O devices must be able to accept responses out of order or restrict themselves to one outstanding non-posted request. A bridge that is between a HyperTransport technology device and an I/O protocol that requires responses to be returned in order must provide sufficient buffering to be able to reorder as many responses as it may have outstanding requests.

The HyperTransport technology supports multiple outstanding read requests and requires in such cases to buffer responses. If, however, the device of FIG. 2 is configured not to support multiple outstanding requests, the entire device may be blocked once a request is placed until the respective response is received and delivered. This is illustrated in FIG. 3 where at any one time only one request is active. This significantly reduces the data throughput since no data traffic takes place if a request is placed but a response is not yet available.

When attaching peripheral devices to HyperTransport compliant systems, response reordering may become a crucial point. For instance, IDE (Integrated Drive Electronics) devices require response data to be in order. Thus, the responses need to be ordered according to the order of the requests to maintain data coherency. In PCI and EHCI (Enhanced Host Controller Interface) interfaces, responses are available out of order and the data needs to be issued to the PCI devices upon request and to the EHCI devices upon arrival. Thus, read responses, in particular those to split transaction read requests, need to be ordered to maintain best system performance. However, conventional response reordering schemes lack reliability and efficiency.

### SUMMARY OF THE INVENTION

An improved response reordering technique is provided that may increase the operating speed and may improve reliability and efficiency.

In one embodiment, a southbridge device is provided that comprises a transmit engine that is adapted to receive non-posted read requests from at least one requestor and transmit upstream commands based on the non-posted read requests. Each of the upstream commands is uniquely identified by a command tag. The southbridge device further comprises a receive engine that is adapted to receive response data in reply to commands that were previously transmitted by the transmit engine. The receive engine is further adapted to transmit responses to the at least one requestor based on the response data. The southbridge device further comprises a response reordering mechanism that is adapted to control the receive engine to transmit the responses in correct order. The response reordering mechanism comprises a buffer unit for storing received response data. The buffer unit has a plurality of buffer elements each being uniquely assigned to one of the command tags.

In another embodiment, an integrated circuit chip comprises a transmit circuit that is adapted to receive non-posted read requests from at least one requester and transmit upstream commands based on the non-posted read requests. Each of the upstream commands is uniquely identified by a command tag. The integrated circuit chip further comprises a receive circuit that is adapted to receive response data in reply to commands previously transmitted by the transmit circuit, and transmit responses to the at least one requestor based on the response data. The integrated circuit chip further comprises a response reordering mechanism that is adapted to control the receive circuit to transmit the responses in correct order. The response reordering mechanism comprises a buffer unit for storing received response data. The buffer unit has a plurality of buffer elements each being uniquely assigned to one of the command tags.

In still another embodiment, there may be provided a computer system that comprises at least one peripheral component and a southbridge. The southbridge comprises a transmit engine that is adapted to receive non-posted read requests from at least one peripheral component controller and transmit upstream commands based on the non-posted read requests. Each of the upstream commands is uniquely identified by a command tag. The southbridge further comprises a receive engine that is adapted to receive response data in reply to commands previously transmitted by the transmit engine, and transmit responses to the at least one peripheral component controller based on the response data. The southbridge further comprises a response reordering mechanism that is adapted to control the receive engine to transmit the responses in correct order. The response reordering mechanism comprises a buffer unit for storing received response data. The buffer unit has a plurality of buffer elements each being uniquely assigned to one of the command tags.

In a further embodiment, a method of operating a southbridge device is provided. The method comprises receiving non-posted read requests from at least one requestor; transmitting upstream commands based on the non-posted read requests where each of the upstream commands is uniquely identified by a command tag; receiving response data in reply to previously transmitted commands; and transmitting responses to the at least one requester based on the response data. Transmitting the responses comprises reordering the received response data by accessing a buffer of the southbridge device. The buffer stores the received response data and has a plurality of buffer elements each being uniquely assigned to one of the command tags.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 is a block diagram illustrating schematically the hardware components of a conventional computer system;

FIG. 2 illustrates the components of a conventional southbridge or I/O hub;

FIG. 3 is a timing chart illustrating the transmission and reception time of requests and responses in a conventional system where multiple outstanding requests are not supported;

FIG. 4 illustrates the components of a southbridge device or I/O hub according to an embodiment;

FIG. 5 illustrates the buffer unit that is a component of the arrangement of FIG. 4, in more detail;

FIG. 6 is a timing chart illustrating the transmission and reception time of requests and responses according to an embodiment;

FIG. 7 is a timing chart similar to that of FIG. 6 but concerning the case where responses are reordered;

FIG. 8 is a flowchart illustrating the request transmission process according to an embodiment;

FIG. 9 is a flowchart illustrating the processing of responses according to an embodiment; and

FIG. 10 is a flowchart illustrating the response ordering process according to an embodiment.

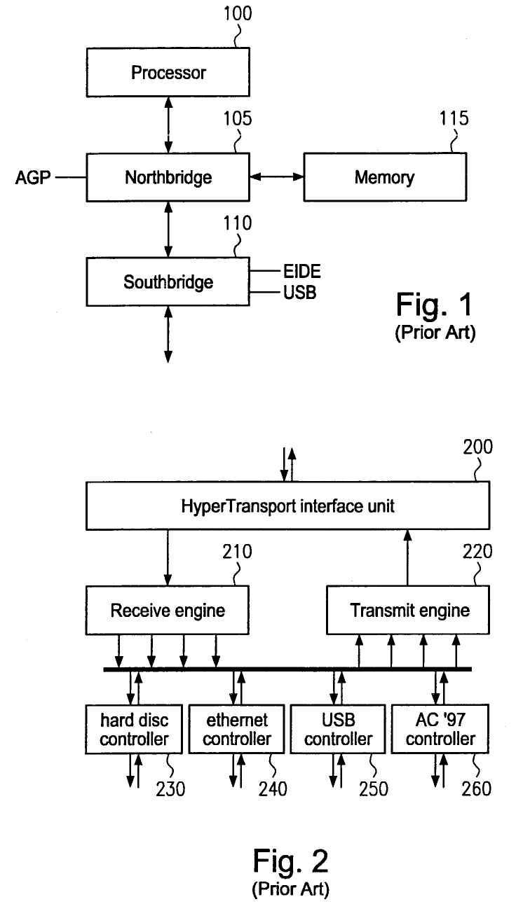

### DETAILED DESCRIPTION OF THE INVENTION

The illustrative embodiments of the present invention will be described with reference to the figure drawings wherein like elements and structures are indicated by like reference numbers.

Referring now to the drawings and in particular to FIG. 4, the hardware components of a southbridge device such as an I/O hub according to an embodiment is depicted. Comparing the arrangement of FIG. 4 with that of FIG. 2, a buffer unit 420 is provided that is connected to the transmit engine 410 and the receive engine 400. Further, the device comprises a response reordering unit 430 that is connected to the transmit engine 410, the receive engine 400, and the buffer unit 420. The function of these units will be explained below in more detail.

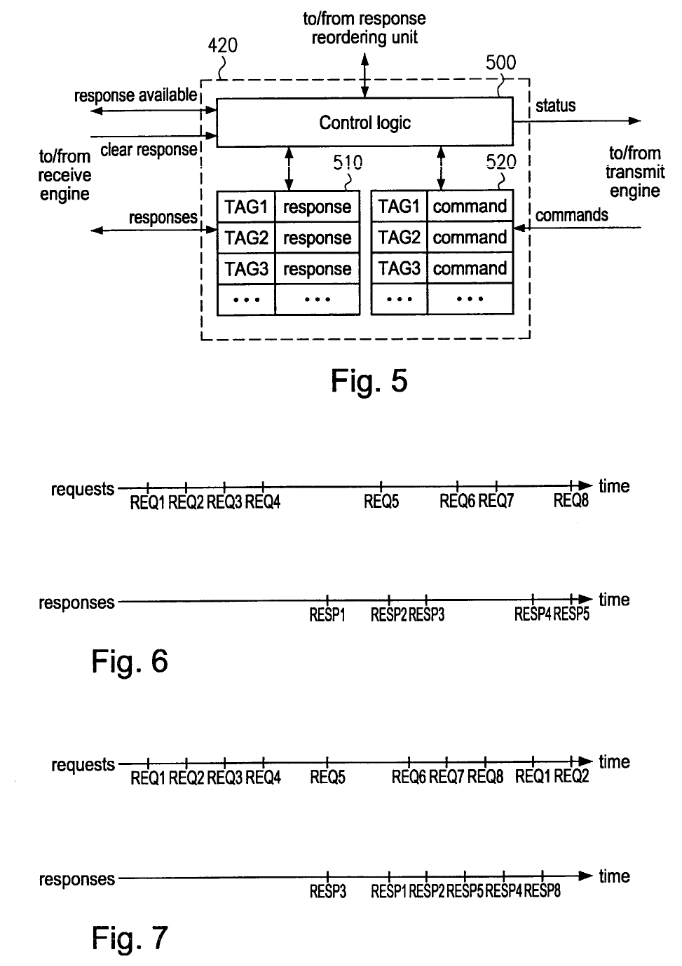

In the present embodiment, the buffer unit 420 that is connected to the transmit engine 410 and the receive engine 400 is adapted to store command identification data that identifies commands transmitted or to be transmitted by the transmit engine 410, and response availability data that specifies response data that has been received by the receive engine 400. The buffer unit 420 of the present embodiment is depicted in more detail in the block diagram of FIG. 5.

As apparent from this figure, the buffer unit 420 comprises a response buffer 510 and a command buffer 520. Both buffers are connected to a control logic 500 for receiving control signals therefrom. The control logic 500 may issue status information to the transmit engine 410, and a response-available signal to the receive engine 400. Further, the control logic 500 may receive a clear-response signal from the receive engine 400. Moreover, the control logic 500 may be connected to the response reordering unit 430.

The response buffer 510 may comprise a plurality of buffer elements that are each uniquely assigned to a command tag. Command tags are data items used to uniquely identify upstream commands. Command tags may be transaction tags as specified in the HyperTransport specification, used to uniquely identify all transactions in progress that were initiated by a single requestor. There may be a predefined number of possible values that the command tags may assume. For instance, the commands may be tagged by eight different tag values. In this case, there will be eight buffer elements in the response buffer 510 to store respective responses.

As apparent from the figure, each buffer element may comprise a tag field for storing the tag, and a response field for storing the response. It is however to be noted that in another embodiment, the tag field may be dropped. In this case, the tags are used to address the buffer element.

It is further to be noted that the response buffer 510 of the present embodiment stores the response data in the form this data was received by the receive engine 400 from the HyperTransport interface unit 200. In another embodiment, the response buffer 510 may store responses in the form in which they are delivered from the receive engine 400 to the respective peripheral component controller 230-260.

Both kinds of response data can be understood as being response availability data since it specifies response data that has been received by the receive engine 400. In another embodiment, the response buffer 510 may store response availability data that differs from the responses themselves. For instance, the response availability data may comprise pointers to responses, or addresses.

The command buffer 520 of the buffer unit 420 may store commands in much the same way as the response buffer 510 stores responses. The commands stored in the command buffer 520 may be commands that were already transmitted by the transmit engine 410. In another embodiment, the buffered commands are commands that are still to be transmitted by the transmit engine 410. The command buffer 520 may also store both, commands that were already transmitted as well as commands that are still to be transmitted. In a further embodiment, the command buffer 520 may store command identification data that is different from the commands themselves, but identifies the commands.

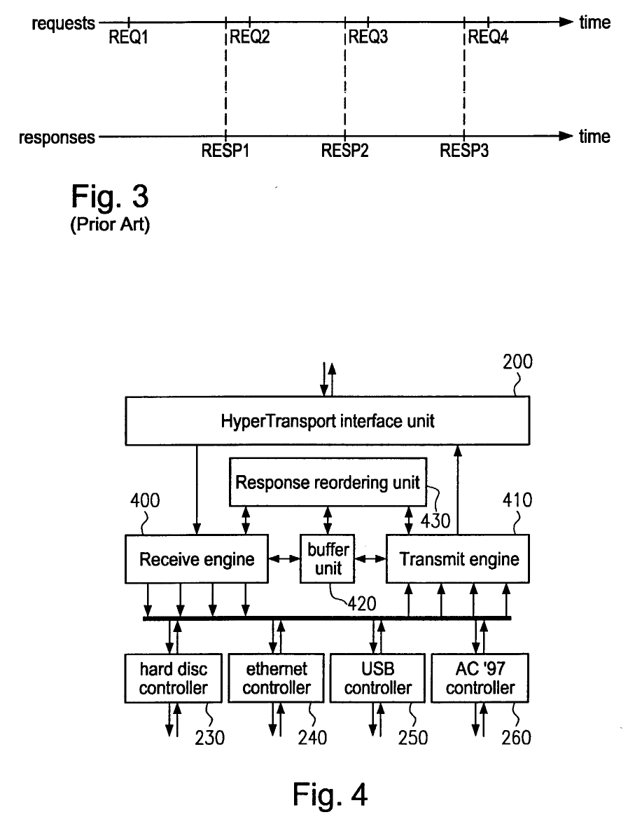

By means of the buffer unit 420, the southbridge device or I/O hub allows the bus masters 230-260 to start more than one outstanding read request, i.e. to start further requests although a previously placed request has not yet been answered by an appropriate response. This can be seen from FIG. 6 which is a timing chart similar to that of FIG. 3, illustrating the capability of placing multiple outstanding requests. In the example of FIG. 6, four requests are placed closely together in time. The second, third and fourth requests are placed although the first request has not yet been served. After a given time, the response to the first request is received. Before the second response is received, a fifth request is placed in the example of FIG. 6. The sequence of requests and responses in the example of FIG. 6 continues with a second and third response, a sixth and seventh request, and so on.

Thus, requests may be placed irrespective of whether responses to previously transmitted requests are available. Moreover, requests can be placed in the form of bursts. A burst is a sequence of requests that are uniquely identified by subsequent command tags. In the example of FIG. 6, the first to fourth requests form such a burst.

Turning now to FIG. 7, another timing chart is provided giving an example of the placement of multiple outstanding requests where the responses are received out of order. After a burst of four requests are placed, a response to the third request in the burst is received. That is, the responses to the first and second requests are received later than the response to the third request. Moreover, it can be seen that responses to requests that are not contained in the burst may arrive earlier than the latest response that pertains to the burst. In the example of FIG. 7, the fifth response is a response to a request that is not part of the burst, but it is received earlier than the fourth response that does pertain to the burst.

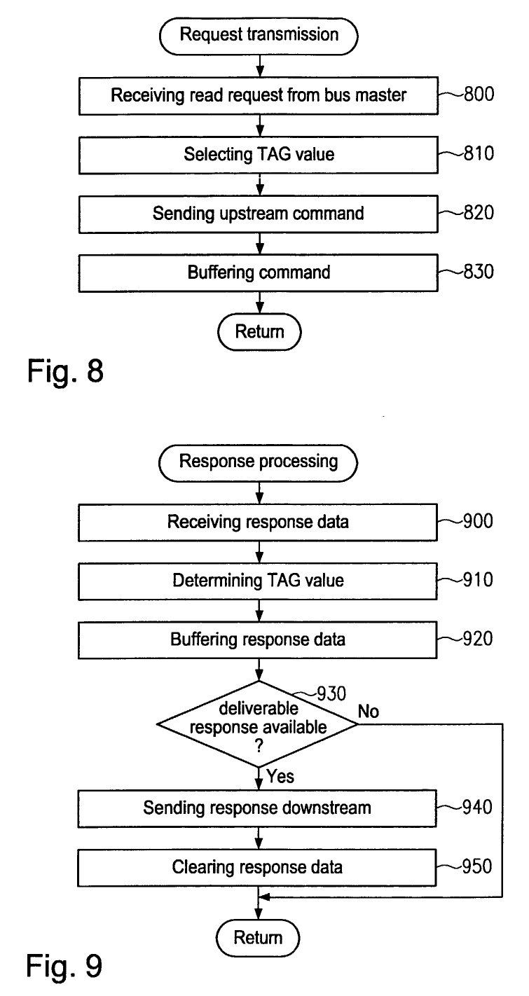

The process of placing requests will now be described with reference to FIG. 8. This figure shows a flowchart beginning with step 800 of receiving a read request from one of the bus masters 230-260. The transmit engine 410 that receives the request, selects a command tag value in step 810 and sends an upstream command in step 820 based on the received read request to the HyperTransport interface unit 200. The transmit engine 410 then buffers the command or any suitable command identification data into the command buffer 520 in step 830.

FIG. 9 is a flowchart illustrating the steps performed in processing received responses. In step 900, the receive engine 400 receives response data from the HyperTransport interface unit 200. The receive engine 400 then determines the corresponding tag value in step 910 and buffers the response data in the response buffer 510 in step 920. As mentioned above, the receive engine 400 may store the response in other formats, or may even store any other kind of response availability data in the buffer 510.

The receive engine 400 may then determine in step 930 whether a deliverable response is available. Although step 930 is depicted in the flowchart of FIG. 9 as being performed after step 920, it is to be noted that the process flow of steps 930 to 950 may be performed completely independently therefrom, even in parallel to steps 900 to 920.

If a deliverable response has been determined as being available, using the response availability data in the response buffer 510, the receive engine 400 sends a corresponding response downstream to the respective bus master 230-260 in step 940, and clears in step 950 the response availability data in the buffer 510.

For performing the steps 930 to 950, the receive engine 400 may interchange signals with the control logic 500 of the buffer unit 420, such as the above mentioned response-available signal and the clear-response signal.

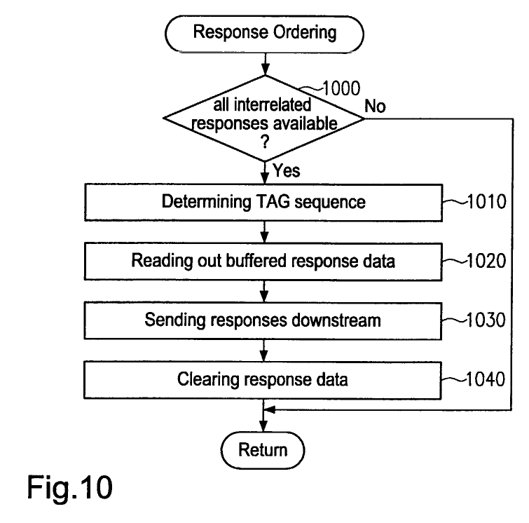

Turning now to FIG. 10, the depicted flowchart illustrates the process of bringing the received responses in order. As discussed above with reference to FIG. 7, responses to placed requests may arrive out of order. Using the buffer unit 420 and the response reordering unit 430, the device of FIG. 4 is provided with a response reordering mechanism that is adapted to control the receive engine 400 to transmit the responses in the correct order. Response reordering according to the present embodiment may make use of the fact that the buffer unit 420 comprises a plurality of buffer elements that are each uniquely assigned to one of the command tags.

In step 1000, the receive engine 400 checks whether all interrelated responses are available. Interrelated responses may be a response to a memory read request where more than sixteen double words are requested from memory. The maximum number of requested read data for one read command is limited by the HyperTransport protocol to sixteen double words, i.e. 32 bits. That is, if more data is requested than 32 bits, a burst of read commands needs to be placed. Responses pertaining to requests in one and the same burst may be understood as being interrelated responses.

If the receive engine 400 determines in step 1000 that all interrelated responses to a given read request are available, it determines the sequence of command tag values in step 1010 for reading the corresponding response data out of the response buffer 510 in step 1020. The responses are then sent downstream in step 1030, and the buffered response data is cleared (step 1040).

As apparent from the foregoing description of the embodiments, the embodiments may make use of the tag field that is defined according to the HyperTransport protocol for each upstream non-posted command. The embodiments provide for each of the used tags an appropriate response buffer element, that is, there may be, e.g., eight buffer elements provided in the embodiments. The responses can be ordered by this tag field. The bus masters have to take care about the available responses and the order of sent out tags for the read commands.

By having the plurality of buffer elements of the buffer unit uniquely assigned to one of the command tags, the system performance may be significantly improved by increasing the operating speed and improving reliability and efficiency.

When having IDE devices attached, the responses are stored temporarily in the buffer, and when all leading requests got responses, they are issued to the device. With PCI, responses are stored in the buffer until the originating device sends a retry signal. With EHCI, there may be no intermediate buffering since the EHCI interface architecture assures the ability to take responses upon arrival.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the appended claims.

What is claimed is:

1. A southbridge device comprising:
a transmit engine adapted to receive non-posted read requests from at least one requestor and transmit upstream commands based on said non-posted read requests, each of said upstream commands being uniquely identified by a command tag;
a receive engine adapted to receive response data in reply to commands previously transmitted by said transmit engine, and transmit responses to said at least one requestor based on said response data; and
a response reordering mechanism adapted to control said receive engine to transmit said responses in correct order, said response reordering mechanism comprising a buffer unit for storing received response data, said buffer unit having a plurality of buffer elements each being uniquely assigned to one of said command tags.

2. The southbridge device of claim 1, wherein said transmit engine is capable of transmitting upstream commands based on plural non-posted read requests from one requestor, irrespective of the presence of resonses to said requests.

3. The southbridge device of claim 2, wherein said transmit engine is capable of transmitting said upstream commands based on bursts of non-posted read requests.

4. The southbridge device of claim 3, wherein the upstream commands based on one burst of non-posted read requests are uniquely identified by subsequent command tags.

5. The southbridge device of claim 1, wherein said non-posted read requests are memory read requests.

6. The southbridge device of claim 1, further comprising: an interface unit connected to said transmit engine and said receive engine for transmitting said upstream commands and receiving said response data via a data link that supports split transactions.

7. The southbridge device of claim 6, wherein said data link that supports split transactions is a HyperTransport compliant data link.

8. The southbridge device of claim 1, wherein the response data received in reply to one of said upstream commands is sixteen double words wide.

9. The southbridge device of claim 1, wherein the maximum number of different command tags is eight.

10. The southbridge device of claim 1, comprising said at least one requestor.

11. The southbridge device of claim 1, wherein said at least one requestor is a hard disc controller.

12. The southbridge device of claim 1, wherein said at least one requester is an ethernet controller.

13. The southbridge device of claim 1, wherein said at least one requester is a USB (Universal Serial Bus) controller.

14. The southbridge device of claim 1, wherein said at least one requestor is an audio codec controller.

15. The southbridge device of claim 1, wherein said transmit engine is adapted to receive non-posted read requests from at least two requestors, and wherein said transmit engine is adapted to arbitrate between said at least two requestors when transmitting said upstream commands.

16. The southbridge device of claim 1, wherein said response reordering mechanism is adapted to provide a response-available signal indicating the availability of specific response data in the buffer unit.

17. The southbridge device of claim 1, wherein said receive engine is adapted to provide a clear-response signal to said response reordering mechanism for clearing specific response data in the buffer unit when transmitting the respective response.

18. The southbridge device of claim 1, being an I/O (Input/Output) hub.

19. An integrated circuit chip comprising:
a transmit circuit adapted to receive non-posted read requests from at least one requestor and transmit upstream commands based on said non-posted read requests, each of said upstream commands being uniquely identified by a command tag;
a receive circuit adapted to receive response data in reply to commands previously transmitted by said transmit circuit, and transmit responses to said at least one requestor based on said response data; and
a response reordering mechanism adapted to control said receive circuit to transmit said responses in correct order, said response reordering mechanism comprising a buffer unit for storing received response data, said buffer unit having a plurality of buffer elements each being uniquely assigned to one of said command tags.

20. A computer system comprising:
at least one peripheral component; and
a southbridge comprising a transmit engine adapted to receive non-posted read requests from at least one peripheral component controller and transmit upstream commands based on said non-posted read requests, each of said upstream commands being uniquely identified by a command tag; and a receive engine adapted to receive response data in reply to commands previously transmitted by said transmit engine, and transmit responses to said at least one peripheral component controller based on said response data;
wherein said southbridge further comprises a response reordering mechanism adapted to control said receive engine to transmit said responses in correct order, said response reordering mechanism comprising a buffer unit for storing received response data, said buffer unit having a plurality of buffer elements each being uniquely assigned to one of said command tags.

21. A method of operating a southbridge device, the method comprising:
receiving non-posted read requests from at least one requestor;
transmitting upstream commands based on said non-posted read requests, each of said upstream commands being uniquely identified by a command tag;
receiving response data in reply to previously transmitted commands; and
transmitting responses to said at least one requestor based on said response data;
wherein transmitting said responses comprises:
reordering said received response data by accessing a buffer of said southbridge device, said buffer storing said received response data and having a plurality of buffer elements each being uniquely assigned to one of said command tags.

22. The method of claim 21, wherein said upstream commands are transmitted based on plural non-posted read requests from one requestor, irrespective of the availability of resonses to said requests.

23. The method of claim 22, wherein said upstream commands are transmitted based on bursts of non-posted read requests.

24. The method of claim 23, wherein the upstream commands based on one burst of non-posted read requests are uniquely identified by subsequent command tags.

25. The method of claim 21, wherein said non-posted read requests are memory read requests.

26. The method of claim 21, wherein transmission of said upstream commands and reception of said response data are performed via a data link that supports split transactions.

27. The method of claim 26, wherein said data link that supports split transactions is a HyperTransport compliant data link.

28. The method of claim 21, wherein the response data received in reply to one of said upstream commands is sixteen double words wide.

29. The method of claim 21, wherein the maximum number of different command tags is eight.

30. The method of claim 21, wherein reception of said non-posted read requests and transmission of said responses are performed from and to requestors incorporated in said southbridge device.

31. The method of claim 21, wherein said at least one requestor is a hard disc controller.

32. The method of claim 21, wherein said at least one requestor is an ethernet controller.

33. The method of claim 21, wherein said at least one requestor is a USB (Universal Serial Bus) controller.

34. The method of claim 21, wherein said at least one requestor is an audio codec controller.

35. The method of claim 21, wherein said non-posted read requests are received from at least two requestors, and the method further comprises:
arbitrating between said at least two requesters when transmitting said upstream commands.

36. The method of claim 21, wherein reordering said received response data comprises:
providing a response-available signal indicating the availability of specific response data in the buffer.

37. The method of claim 21, wherein transmitting said responses further comprises:
providing a clear-response signal for clearing in the buffer response data relating to transmitted responses.

38. The method of claim 21, for operating an I/O (Input/Output) hub.
